(19) United States
(12) Patent Application Publication
(10) Pub. No.: US 2025/0117028 A1
(43) Pub. Date: Apr. 10, 2025

(54) AUTOMATED VALET PARKING MANAGEMENT SYSTEM AND AUTOMATED VALET PARKING MANAGEMENT METHOD

(71) Applicant: TOYOTA JIDOSHA KABUSHIKI KAISHA, Toyota-shi (JP)

(72) Inventor: Hiroya CHIBA, Fuji-shi (JP)

(73) Assignee: TOYOTA JIDOSHA KABUSHIKI KAISHA, Toyota-shi (JP)

(21) Appl. No.: 18/800,199

(22) Filed: Aug. 12, 2024

(30) Foreign Application Priority Data
Oct. 10, 2023 (JP) 2023-175193

(51) Int. Cl. G05D 1/698; G06Q 50/40

(52) U.S. Cl. CPC G05D 1/6987; G06Q 50/40

(57) ABSTRACT

An automated valet parking management system manages automated valet parking in a parking lot. The automated valet parking management system includes: one or more recognition sensors configured to recognize a surrounding situation of the parking lot; and one or more processors configured to execute: an allocation process of allocating a first target exit space to an exit vehicle from the parking lot; a monitoring process of using the one or more recognition sensors to detect entry or approach of an external vehicle to the first target exit space from outside the parking lot after the first target exit space is allocated to the exit vehicle; and a countermeasure process of allocating a second target exit space to the exit vehicle, or decelerating or stopping the exit vehicle that is exiting to the first target exit space, when the entry or the approach is detected by the monitoring process.

### CROSS-REFERENCES TO RELATED APPLICATION

The present disclosure claims priority under 35 U.S.C. § 119 to Japanese Patent Application No. 2023-175193, filed on Oct. 10, 2023, which is incorporated herein by reference in its entirety.

### BACKGROUND

### Technical Field

The present disclosure relates to a technique for managing automated valet parking (AVP) in a parking lot.

### Background Art

JP 2023-032601 A discloses an automated entry/exit system including an entry/exit control server that manages and controls entry/exit of a vehicle. When receiving an entry/exit request for using one of a plurality of platforms from a user using an automated parking service, the entry/exit control server determines the degree of congestion of the requested platform in an entry/exit time zone designated by the user. When the degree of congestion of the requested platform is high, the entry/exit control server proposes, to the user, the use of another platform included in the plurality of platforms and having a degree of congestion lower than that of the requested platform.

JP 2020-049983 A and JP 2020-166719 A also disclose techniques related to automated valet parking.

### SUMMARY

In automated valet parking in a parking lot, when an external vehicle accidentally enters a target exit space from the outside of the parking lot after the target exit space is allocated to an exit vehicle, smooth management of entry and exit of a vehicle in the automated valet parking is hindered.

The present disclosure has been made in view of the problem described above, and an object of the present disclosure is to provide a technique that enables smoother entry and exit of a vehicle in automated valet parking.

An automated valet parking management system according to the present disclosure manages automated valet parking in a parking lot. The automated valet parking management system includes: one or more recognition sensors configured to recognize a surrounding situation of the parking lot; and one or more processors. The one or more processors are configured to execute: an allocation process of allocating a first target exit space to an exit vehicle from the parking lot; a monitoring process of using the one or more recognition sensors to detect entry or approach of an external vehicle to the first target exit space from outside the parking lot after the first target exit space is allocated to the exit vehicle; and a countermeasure process of allocating a second target exit space to the exit vehicle, or decelerating or stopping the exit vehicle that is exiting to the first target exit space, when the entry or the approach is detected by the monitoring process.

An automated valet parking management method according to the present disclosure manages automated valet parking in a parking lot. The automated valet parking management method, which is executed by a computer, includes: an allocation process of allocating a first target exit space to an exit vehicle from the parking lot; a monitoring process of using one or more recognition sensors configured to recognize a surrounding situation of the parking lot to detect entry or approach of an external vehicle to the first target exit space from outside the parking lot after the first target exit space is allocated to the exit vehicle; and a countermeasure process of allocating a second target exit space to the exit vehicle, or decelerating or stopping the exit vehicle that is exiting to the first target exit space, when the entry or the approach is detected by the monitoring process.

According to the present disclosure, after the first target exit space is allocated to the exit vehicle from the parking lot, whether or not an external vehicle enters or approaches the first target exit space from outside the parking lot is monitored. Then, when the external vehicle actually enters or approaches, the countermeasure process described above is executed. This enables smoother entry and exit.

### BRIEF DESCRIPTION OF THE DRAWINGS

FIG. 1 is a conceptual diagram used to describe an overview of automated valet parking according to an embodiment;

FIG. 2 is a block diagram showing a configuration example of an automated valet parking management system according to an embodiment;

FIG. 3 is a diagram illustrating a specific example of a parking lot according to an embodiment;

FIG. 4 is a flowchart illustrating processing steps related to a countermeasure process according to a first example;

FIG. 5 is a flowchart illustrating processing steps related to the countermeasure process according to a second example;

FIG. 6 is a flowchart illustrating processing steps related to the countermeasure process according to a third example;

FIG. 7 is a flowchart illustrating processing steps related to the countermeasure process according to a fourth example;

FIG. 8 is a flowchart illustrating processing steps related to the countermeasure process according to a fifth example; and

FIG. 9 is a diagram used to describe a specific example of a designated position P shown in FIG. 8.

### DETAILED DESCRIPTION

### 1. Overview of Automated Valet Parking

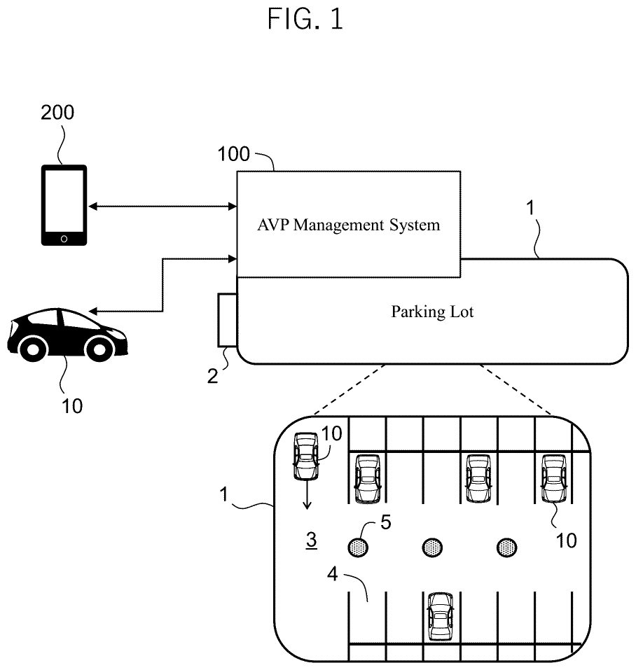

FIG. 1 is a conceptual diagram used to describe an overview of automated valet parking (AVP) according to an embodiment.

The vehicle 10 is adapted to the automated valet parking in a parking lot 1. The vehicle 10 is able to automatically travel at least in the parking lot 1 independently of a driving operation by a driver. More specifically, the vehicle 10 is provided with one or more recognition sensors (for example, a camera) for recognizing a surrounding situation of the vehicle 10. The vehicle 10 automatically travels in the parking lot 1 while recognizing the surrounding situation by using the one or more recognition sensors. It should be noted that the vehicle 10 may be an automated driving vehicle that can automatically travel even outside the parking lot 1.

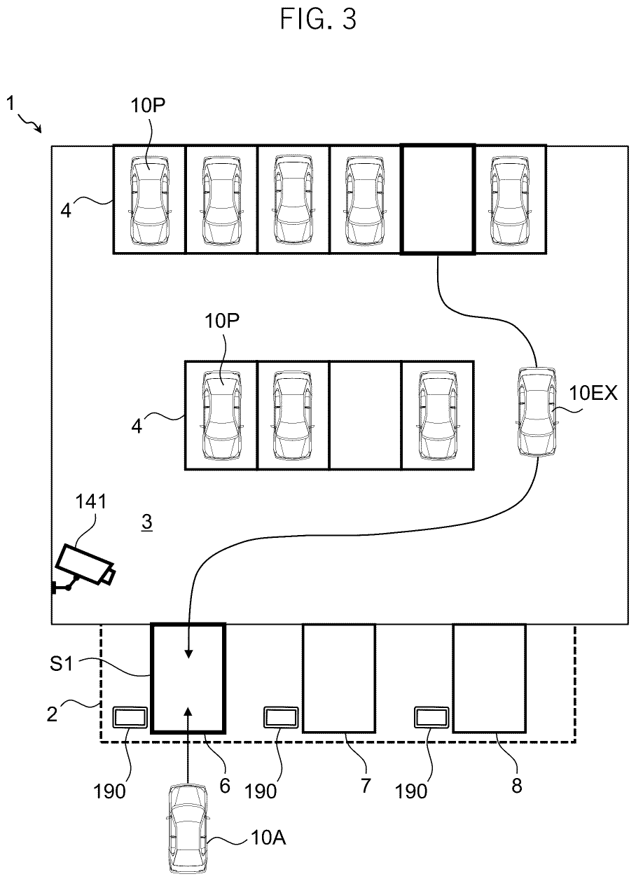

The parking lot 1 includes a platform 2, a passage 3, and a plurality of parking spaces 4. The vehicle 10 that enters the parking lot 1 stops at a drop-off space of the platform 2, and a user gets off the vehicle 10 there. On the other hand, the vehicle 10 that exits the parking lot 1 stops at a pick-up space of the platform 2, and the user gets on the vehicle 10 there. In other words, the drop-off space corresponds to an entry space, and the pick-up space corresponds to an exit space. More specifically, the platform 2 includes one or more entry spaces and one or more exit spaces. The one or more entry spaces and the one or more exit spaces may be provided separately, or may be provided as one or more common spaces, each of which can be dynamically changed between the entry space and the exit space. A specific example of the parking lot 1 including the platform 2 will be described below with reference to FIG. 3.

The passage 3 is an area in which the vehicle 10 travels. The parking space 4 is a space in which the vehicle 10 is parked. For example, the parking space 4 is partitioned by a partition line. In addition, a plurality of markers 5 are arranged in the parking lot 1. The marker 5 is used to guide the vehicle 10 in the parking lot 1. For example, the vehicle 10 acquires an image of the surroundings using a camera, and recognizes the marker 5 based on the image. Then, based on a result of recognition of the marker 5, the vehicle 10 performs a localization process that estimates a position of the vehicle 10 in the parking lot 1 with high accuracy. The vehicle 10 automatically travels in the parking lot 1 based on the vehicle position estimated by the localization process.

It should be noted that the parking lot 1 may be used not only by the vehicle 10 adapted to the automated valet parking but also by a general vehicle other than the vehicle 10.

An automated valet parking management system 100 manages the automated valet parking in the parking lot 1. The automated valet parking management system 100 is hereinafter referred to as an “AVP management system 100”. The AVP management system 100 may include a local management device installed in the parking lot 1 and a management center that controls a plurality of parking lots 1.

The AVP management system 100 is capable of communicating with the vehicle 10 and manages the vehicle 10. For example, the AVP management system 100 grasps a position and a state of each vehicle 10 in the parking lot 1. The AVP management system 100 allocates the parking space 4 to the vehicle 10. The AVP management system 100 issues a movement instruction (for example, an entry instruction, an exit instruction) to the vehicle 10 in the parking lot 1. The AVP management system 100 may provide the vehicle 10 with map information of the parking lot 1. For example, the AVP management system 100 generates a target route for the vehicle 10 in the parking lot 1 and provides the vehicle 10 with information on the target route. The AVP management system 100 may remotely control the vehicle 10 in the parking lot 1.

Moreover, the AVP management system 100 manages information on the user of the automated valet parking service. The AVP management system 100 is able to communicate with a user terminal 200 operated by the user.

Hereinafter, an example of a flow when a user X uses the automated valet parking service will be described. It is assumed that member information of the user X is registered in advance in the AVP management system 100.

First, the user X makes a reservation of the automated valet parking. For example, the user X operates the user terminal 200 to input information, such as ID information of the user X, a desired parking lot 1, a desired date of use, and a desired time of use (i.e., a scheduled entry time and a scheduled exit time). The user terminal 200 sends reservation information including the input information to the AVP management system 100. The AVP management system 100 executes a reservation process based on the reservation information and sends a reservation completion notification to the user terminal 200. In addition the AVP management system 100 sends authentication information associated with the reservation information to the user terminal 200. The user terminal 200 receives the authentication information and holds the received authentication information.

Entry (i.e., check-in) of the vehicle 10 into the parking lot 1 is as follows.

The vehicle 10 carrying the user X arrives and stops at the platform 2 of the parking lot 1. At the platform 2, the user X (and other occupants if any) gets off the vehicle 10. Then, the user X requests the entry of the vehicle 10 by using the authentication information held in the user terminal 200. In response to the entry request, the AVP management system 100 conducts authentication of the user X. When the authentication is completed, authority to operate the vehicle 10 is transferred from the user X to the AVP management system 100. The AVP management system 100 executes an entry process with respect to the vehicle 10.

In the entry process, the AVP management system 100 communicates with the vehicle 10 to activate the vehicle 10 (power ON).

Moreover, the AVP management system 100 allocates an available parking space 4 to the vehicle 10 by referring to a usage status of the parking lot 1. Then, the AVP management system 100 communicates with the vehicle 10 to send an entry instruction to the vehicle 10. The entry instruction includes information on the allocated parking space 4 and the map information of the parking lot 1. The AVP management system 100 may specify a target route from the platform 2 to the allocated parking space 4. In this example, the entry instruction includes information on the specified target route.

In response to the entry instruction, the vehicle 10 starts vehicle travel control. Specifically, the vehicle 10 automatically travels on the passage 3 from the platform 2 to the allocated parking space 4, and automatically parks in the allocated parking space 4. At this time, the vehicle 10 may travel along the target route specified by the AVP management system 100. The AVP management system 100 may communicate with the vehicle 10 to remotely control the automated travel of the vehicle 10.

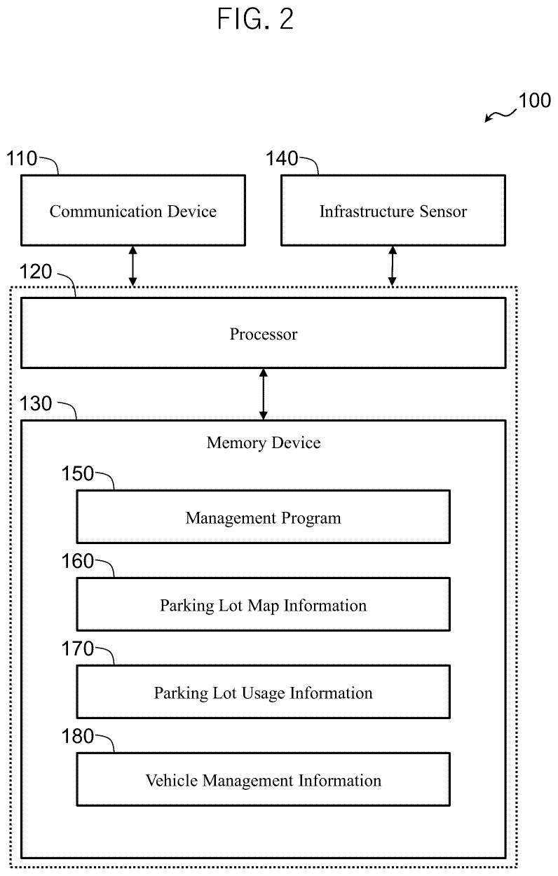

When the parking is completed, the vehicle 10 notifies the AVP management system 100 of the parking completion. Alternatively, the AVP management system 100 may use an infrastructure sensor 140 (see FIG. 2) installed in the parking lot 1 to detect that the parking of the vehicle 10 has been completed. After the parking is completed, the AVP management system 100 communicates with the vehicle 10 to deactivate the vehicle 10 (power OFF). The AVP management system 100 holds information on the parking space 4 of the vehicle 10 in association with the user X.

Exit (i.e., check-out) of the vehicle 10 from the parking lot 1 is as follows.

The user X requests the exit of the vehicle 10 by using the user terminal 200. The exit request includes information, such as the authentication information. In response to the exit request, the AVP management system 100 conducts authentication of the user X and executes an exit process with respect to the vehicle 10.

In the exit process, the AVP management system 100 communicates with the vehicle 10 to activate the vehicle 10 (power ON).

Moreover, the AVP management system 100 communicates with the vehicle 10 to send an exit instruction to the vehicle 10. The exit instruction includes a position of the platform 2 (i.e., a target exit space) and the map information of the parking lot 1. The AVP management system 100 may specify a target route from the parking space 4 to the platform 2. In this example, the exit instruction includes information on the specified target route.

In response to the exit instruction, the vehicle 10 starts the vehicle travel control. Specifically, the vehicle 10 automatically travels on the passage 3 from the parking space 4 to the platform 2. At this time, the vehicle 10 may travel along the target route specified by the AVP management system 100. The AVP management system 100 may communicate with the vehicle 10 to remotely control the automated travel of the vehicle 10.

The vehicle 10 arrives and stops at the platform 2. The authority to operate the vehicle 10 is transferred from the AVP management system 100 to the user X. The user X (and other occupants if any) gets on the vehicle 10. The vehicle 10 starts moving toward a next destination.

### 2. Configuration Example of AVP Management System

FIG. 2 is a block diagram showing a configuration example of the AVP management system 100 according to the embodiment. The AVP management system 100 includes a communication device 110, one or more processors 120 (hereinafter, simply referred to as a processor 120, or “processing circuitry”), one or more memory devices 130 (hereinafter, simply referred to as a memory device 130), and the infrastructure sensor 140.

The communication device 110 communicates with the vehicle 10 and the user terminal 200.

The processor 120 executes various processes. For example, the processor 120 includes a central processing unit (CPU). The processor 120 communicates with the vehicle 10 and the user terminal 200 via the communication device 110. In addition, the processor 120 manages the automated valet parking in the parking lot 1. For example, the processor 120 allocates the parking space 4 to the vehicle 10. Further, the processor 120 instructs the vehicle 10 in the parking lot 1 to move. Furthermore, the processes executed by the processor 120 includes an “allocation process”, a “monitoring process”, and a “countermeasure process” described below.

The memory device 130 stores various kinds of information. The memory device 130 includes a volatile memory, a nonvolatile memory, a hard disk drive (HDD), a solid state drive (SSD), or any combination thereof. The processor 120 reads out the various kinds of information from the memory device 130 and stores the various kinds of information in the memory device 130.

The infrastructure sensor 140 is, for example, a camera, and configured to recognize the parking lot 1 and the surrounding situation. The infrastructure sensor 140 includes, for example, one or more infrastructure sensors (not illustrated) configured to recognize the situation inside the parking lot 1, and one or more infrastructure sensors 141 (see FIG. 3) configured to recognize a surrounding situation of the parking lot 1. The latter one or more infrastructure sensors 141 correspond to an example of the “one or more recognition sensors” according to the present disclosure.

A management program 150 is a computer program for managing the automated valet parking. The processor 120 executes the management program 150, thereby realizing various functions of the AVP management system 100 (the processor 120). The management program 150 is stored in the memory device 130. The management program 150 may be recorded in a non-transitory computer-readable recording medium.

Moreover, the memory device 130 stores information, such as parking lot map information 160, parking lot usage information 170, and vehicle management information 180. The parking lot map information 160 is the map information of the parking lot 1. The parking lot map information 160 indicates the arrangement of elements, such as the platform 2, the passage 3, the parking spaces 4, and the markers 5 in the parking lot 1. The parking lot usage information 170 indicates a usage status (availability) of each of the parking spaces 4 and the platform 2 in the parking lot 1.

The vehicle management information 180 is information for managing the vehicle 10 which is a target of the automated valet parking. For example, the vehicle management information 180 includes a vehicle ID, user information, entry/exit time information, and position information. The vehicle ID, the user information, the entry/exit time information, and the position information are associated with each other for each vehicle 10. The vehicle ID is identification information of the vehicle 10. The user information is information on the user who uses the vehicle 10. The entry/exit time information is information on entry and exit times of the vehicle 10. For example, the entry/exit time information includes a scheduled entry time, an actual entry time, and a scheduled exit time. The position information indicates the position of the vehicle 10 in the parking lot 1. For example, the position information indicates the position or the identification information of the parking space 4 allocated to the vehicle 10. When the vehicle 10 is traveling in the parking lot 1, the position information may indicate a traveling position of the vehicle 10. The current traveling position of the vehicle 10 is obtained by the localization process performed by the vehicle 10. The processor 120 is able to obtain the information on the current traveling position from the vehicle 10 by communicating with the vehicle 10.

Furthermore, the AVP management system 100 may include a display device 190. The display device 190 is configured to display various kinds of information with respect to an external (or extraneous) vehicle 10A that travels from the outside of the parking lot 1 toward the platform 2 for the entry. For example, the display device 190 is installed for each of drop-off/pick-up spaces 6-8 as shown in FIG. 3. The various kinds of information includes a warning or caution against the external vehicle (i.e., intruding vehicle) 10A (see step S116 or S208 described below).

3. Countermeasure Against Vehicle Entry into Target Exit Space

FIG. 3 is a diagram illustrating a specific example of the parking lot 1 according to the embodiment. The parking lot 1 includes the platform 2, the passage 3, and the plurality of parking spaces 4. In the example shown in FIG. 3, the platform 2 includes three drop-off/pick-up spaces 6, 7, and 8 that can be used as the entry space or the exit space. For example, the drop-off/pick-up spaces 6, 7, and 8 are partitioned by partition lines. In the following explanation, the vehicle 10 that exits the parking lot 1 is referred to as an “exit vehicle 10EX”, and the vehicle 10 that is parked in the parking space 4 is referred to as a “parked vehicle 10P”.

When the parked vehicle 10P exits, the parked vehicle 10P becomes the exit vehicle 10EX. At the time of the exit, the processor 120 executes the “allocation process” of allocating a first target exit space S1 to the exit vehicle 10EX. The exit vehicle 10EX to which the first target exit space S1 is allocated moves from the parking space 4 to the first target exit space S1.

FIG. 3 shows an exit vehicle 10EX moving from the parking space 4 toward the drop-off/pick-up space 6 allocated as the first target exit space S1. In addition, FIG. 3 shows an external vehicle 10A that is about to enter the drop-off/pick-up space 6 allocated as the first target exit space S1 for the exit vehicle 10EX.

As in the scene illustrated in FIG. 3, when the external vehicle 10A accidentally enters the first target exit space S1 from the outside of the parking lot 1 after the first target exit space S1 is allocated to the exit vehicle 10EX, the exit of the exit vehicle 10EX is obstructed. Further, the obstruction of the exit of the exit vehicle 10EX may lead to obstruction of exit of another exit vehicle 10EX or obstruction of entry of another vehicle 10 that is trying to enter the parking lot 1 correctly. In this way, the presence of the external vehicle 10A that enters the first target exit space S1 hinders smooth management of the entry and exit in the automated valet parking. In addition, the external vehicle 10A that is assumed to enter or approach in this way is, for example, a vehicle 10 scheduled to enter the parking lot 1 for the use of the automated valet parking.

In order to enable smoother entry and exit in the automated valet parking, the processes executed by the processor 120 according to the present embodiment includes the following “monitoring process” and “countermeasure process”.

After the first target exit space S1 is allocated, the monitoring process uses the infrastructure sensor 141 to detect entry or approach of the external vehicle 10A into the first target exit space S1 from the outside of the parking lot 1. More specifically, a “time period after the allocation of the first target exit space S1” in which the monitoring of the first target exit space S1 by the monitoring process is executed includes not only a time period in which the exit vehicle 10EX is moving toward the first target exit space S1 based on the instruction from the processor 120 (see FIG. 3) but also a time period before the exit vehicle 10EX starts moving based on the instruction. The infrastructure sensor 141 is installed at a location where the drop-off/pick-up spaces 6-8 of the platform 2 can be monitored.

When the entry or the approach of the external vehicle 10A is detected by the monitoring process, the countermeasure process allocates a second target exit space S2 to the exit vehicle 10EX, or decelerates or stops the exit vehicle 10EX during the exit to the first target exit space S1.

First to fifth examples of the countermeasure process according to the present embodiment will be described below.

### 3-1. First Example

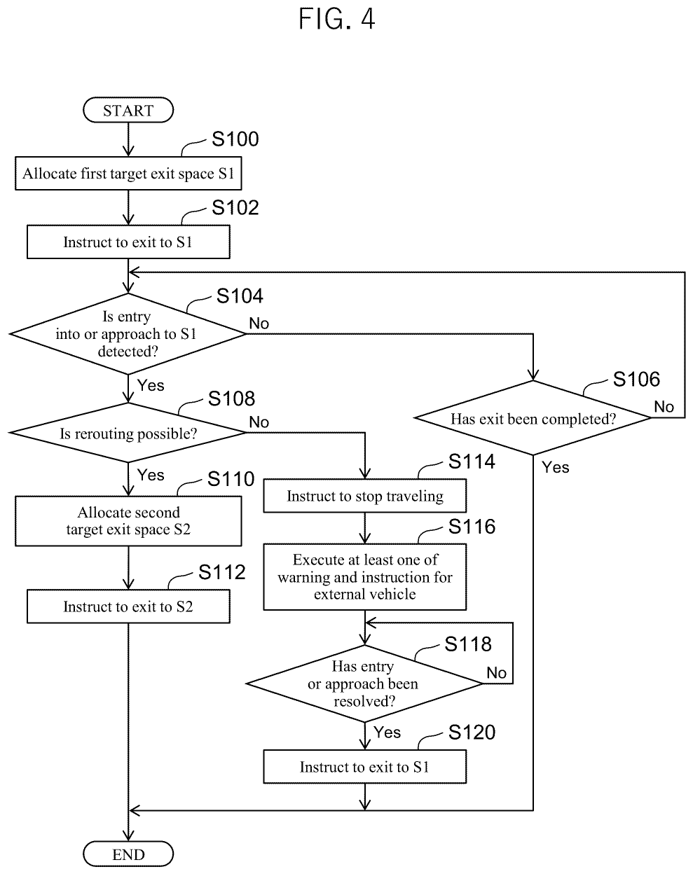

FIG. 4 is a flowchart illustrating processing steps related to the countermeasure process according to the first example. The processor 120 starts the processing of this flowchart when, for example, the processor starts the exit of the parked vehicle 10P in response to the exit request from the user X who operates the user terminal 200.

In step S100, the processor 120 executes the “allocation process” of allocating the first target exit space S1 to the exit vehicle 10EX. In the allocation process, the processor 120 determines the first target exit space S1 based on, for example, the parking lot usage information 170.

Then, in step S102, the processor 120 instructs the exit vehicle 10EX to exit to the first target exit space S1.

Then, in step S104, the processor 120 uses the infrastructure sensor 141 to determine whether or not the external vehicle 10A has entered or approached the first target exit space S1 from the outside of the parking lot 1 (monitoring process). To be specific, when detecting that the external vehicle 10A is within the first target exit space S1 by using the infrastructure sensor 141, the processor 120 determines that the external vehicle 10A has entered the first target exit space S1. Also, in the monitoring process, the processor 120 uses the infrastructure sensor 141 to detect a distance D of the external vehicle 10A from the first target exit space S1. When detecting that this distance D has fallen below a designated threshold value TH, the processor 120 determines that the external vehicle 10A has approached the first target exit space S1. In addition, detecting the approach of the external vehicle 10A to the first target exit space S1 in this way corresponds to predicting the entry of the external vehicle 10A into the first target exit space S1.

When neither the entry nor the approach of the external vehicle 10A is detected (step S104; No), the processing proceeds to step S106. In step S106, the processor 120 uses, for example, the infrastructure sensor 141 to determine whether or not the exit of the exit vehicle 10EX has been completed. As a result, when the exit has not been completed (step S106; No), the processing returns to step S104. On the other hand, when the exit has been completed (step S106; Yes), the processing of the present flowchart is ended.

On the other hand, when the entry or the approach of the external vehicle 10A is detected (step S104; Yes), the processing proceeds to step S108. In step S108, the processor 120 determines whether or not the second target exit space S2 different from the first target exit space S1 can be allocated to the exit vehicle 10EX. In other words, the processor 120 determines whether or not the exit route of the exit vehicle 10EX can be changed (i.e., whether or not rerouting is possible). When, for example, any of other drop-off/pick-up spaces 6-8 not allocated to the first target exit space S1 is available, the processor 120 determines that the rerouting is possible. In addition, the determination that the rerouting is possible may include a determination that there is no obstacle in the route from the current position of the exit vehicle 10EX to any of the other unoccupied drop-off/pick-up spaces 6-8.

When the rerouting is possible (step S108; Yes), the processing proceeds to step S110. In step S110, the processor 120 allocates any one of the other unoccupied drop-off/pick-up spaces 6-8 to the exit vehicle 10EX as the second target exit space S2. Then, in step S112, the processor 120 instructs the exit vehicle 10EX to exit to the second target exit space S2.

On the other hand, when the rerouting is not possible (step S108; No), that is, when the second target exit space S2 is not allocatable to the exit vehicle 10EX, the processing proceeds to step S114. For example, when none of the other drop-off/pick-up spaces 6-8 are available, or when there is an obstacle on the route of the exit vehicle 10EX although any of the other drop-off/pick-up spaces 6-8 is available corresponds to when the rerouting is not possible. In step S114, the processor 120 instructs the exit vehicle 10EX to stop traveling. It should be noted that, when the rerouting is not possible (step S108; No), the processor 120 may decelerate the exit vehicle 10EX instead of stopping the exit vehicle 10EX as in a process in step S200 described below.

In step S116 subsequent to step S114, the processor 120 executes at least one of warning and instruction for the external vehicle (i.e., intruding vehicle) 10A.

The warning to the external vehicle 10A mentioned here indicates that, for example, “the first target exit space S1 is a place used for the exit of another vehicle 10 (i.e., the exit vehicle 10EX)”. The warning is performed using, for example, the display device 190 associated with any one of the drop-off/pick-up spaces 6-8 corresponding to the first target exit space S1. Alternatively, if the AVP management system 100 is in a state of being able to communicate with the external vehicle 10A, the warning may be performed using a user terminal carried by a user of the external vehicle 10A or a display device mounted on the external vehicle 10A, in addition to or instead of the display device 190. It should be noted that the warning may be performed with at least one of sound and voice using a speaker.

Moreover, the instruction to the external vehicle 10A mentioned here is given on condition that the external vehicle 10A is a vehicle adapted to the automated valet parking in the parking lot 1. The instruction includes requesting the external vehicle 10A to make an early preparation such that the automated travel of the external vehicle 10A in the automated valet parking can be started quickly. The preparation corresponds to, for example, not turning off the power of the external vehicle 10A after the external vehicle 10A enters the first target exit space S1. The instruction also includes a request for the entry into the parking space 4 in the parking lot 1 to the external vehicle 10A that is in the preparation state in which the automated travel is possible. It should be noted that, in step S116, only one of the warning and the instruction may be executed. In addition, according to the instruction described above, the entry of the external vehicle 10A is permitted prior to the exit vehicle 10EX. However, the instruction contributes to smooth entry and exit management in the parking lot 1 as a whole.

In step S118 subsequent to step S116, the processor 120 determines whether or not the entry or the approach performed by the external vehicle 10A has been resolved by using, for example, the infrastructure sensor 141. For example, when the external vehicle 10A moves away from the first target exit space S1 in response to the warning described above, or when the external vehicle 10A starts the entry into the parking space 4 in response to the instruction described above, the entry or the approach is resolved.

When the entry or the approach is not resolved (step S118; No), the processor 120 repeatedly executes the process in step S118, that is, the exit vehicle 10EX is caused to wait in a stopped state.

On the other hand, when the entry or the approach is resolved (step S118; Yes), that is, when the first target exit space S1 becomes available, the processing proceeds to step S120. In step S120, the processor 120 instructs the exit vehicle 10EX to exit to the first target exit space S1 again.

According to the first example described above, after the first target exit space S1 is allocated to the exit vehicle 10EX, it is monitored whether or not the external vehicle 10A has entered or approached the first target exit space S1 (monitoring process). Then, when the external vehicle 10A actually has entered or approached, the second target exit space S2 different from the first target exit space S1 is allocated to the exit vehicle 10EX (countermeasure process). This enables smoother entry and exit.

More specifically, according to the first example, by performing the monitoring described above, it is possible to promptly recognize the entry or the approach of the external vehicle 10A into or to the first target exit space S1, compared to when the monitoring is not performed. As a result, it is possible to quickly start to determine whether or not the allocation of the second target exit space S2 (that is, rerouting) is possible. As a result, the second target exit space S2 can be quickly allocated. Further, when the rerouting is not possible, the next best countermeasure (for example, stopping the exit vehicle 10EX) can be promptly performed. In addition, by executing the allocation of the second target exit space S2 as the countermeasure process, it is possible to effectively reduce a decrease in the operation rate of the automated valet parking service by the AVP management system 100 due to the presence of the external vehicle 10A.

Moreover, when, despite the fact that the first target exit space S1 cannot be used due to the presence of the external vehicle 10A, the exit vehicle 10EX moves to the vicinity of the platform 2 including the first target exit space S1 without grasping the fact and then stops, the presence of the stopped exit vehicle 10EX may easily obstruct the entry or the exit of another vehicle 10. In contrast, according to the first example, when the second target exit space S2 cannot be allocated, the processor 120 promptly stops the exit vehicle 10EX. This increases the possibility that the stopped exit vehicle 10EX will not obstruct the entry or the exit of another vehicle 10.

Furthermore, according to the first example, when the second target exit space S2 can be allocated, the exit of the exit vehicle 10EX toward the second target exit space S2 is executed with priority over the stop of the exit vehicle 10EX (steps S108 to S114). As a result, the decrease in the operation rate due to the presence of the external vehicle 10A can be more effectively reduced.

### 3-2. Second Example

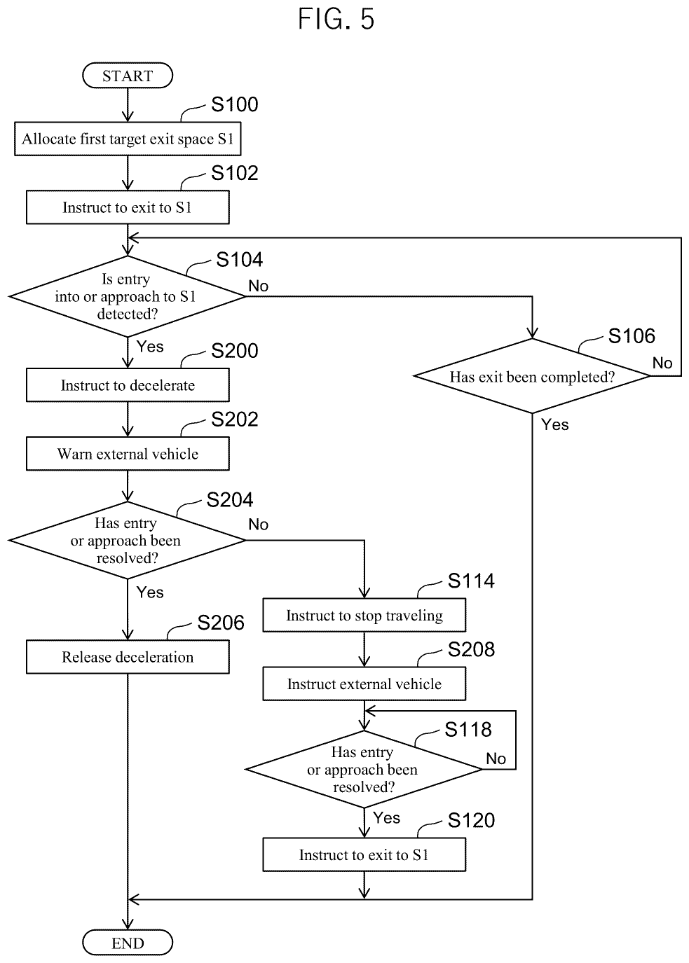

FIG. 5 is a flowchart illustrating processing steps related to the countermeasure process according to the second example. The processing of this flowchart is different from the processing of the flowchart shown in FIG. 4 in the following points.

In FIG. 5, when the entry or the approach of the external vehicle 10A into or to the first target exit space S1 is detected (step S104; Yes), the processing proceeds to step S200. In step S200, the processor 120 instructs the exit vehicle 10EX to decelerate.

Then, in step S202, the processor 120 executes a warning to the external vehicle 10A. The warning mentioned here is executed in the same manner as the warning in step S116. Then, in step S204, the processor 120 determines whether or not the entry or the approach of the external vehicle 10A has been resolved. As a result, when the entry or the approach is resolved by the warning (step S204; Yes), the processor 120 instructs the exit vehicle 10EX to release the deceleration (step S206).

On the other hand, when the entry or the approach is not resolved only by the warning (step S204; No), the processor 120 executes a process of instructing the exit vehicle 10EX to stop traveling (step S114) and processes associated therewith (steps S208, S118, and S120). The processes related to the instruction to the external vehicle 10A in step S208 is the same as the processes related to the instruction in step S116.

According to the second example described above, when the entry or the approach of the external vehicle 10A is detected by the monitoring process described above, the processor 120 decelerates the exit vehicle 10EX during the exit to the first target exit space S1 (countermeasure process). As a result, as compared with an example in which, because the monitoring process is not included, it becomes clear that the first target exit space S1 cannot be used due to the presence of the external vehicle 10A after the exit vehicle 10EX has moved to the vicinity of the platform 2, the processor 120 can quickly decelerate the exit vehicle 10EX and then quickly start a countermeasure, such as the warning (step S202). This can lead to early resolution of the entry or the approach of the external vehicle 10A. Also, even when the entry or the approach is not resolved, the second best countermeasure can be started quickly. Thus, the second example also enables smoother entry and exit.

### 3-3. Third Example

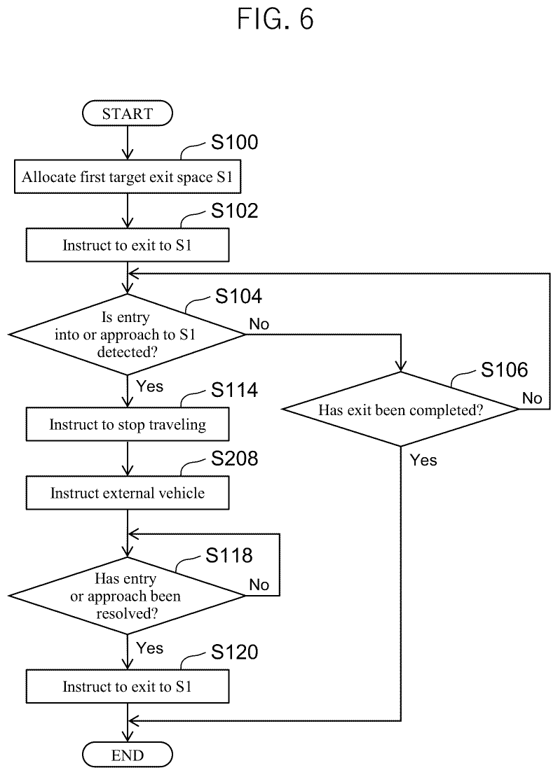

FIG. 6 is a flowchart illustrating processing steps related to the countermeasure process according to the third example. The processing of this flowchart is different from the processing of the flowcharts shown in FIGS. 4 and 5 in the following points.

In FIG. 6, when the entry or the approach of the external vehicle 10A into or to the first target exit space S1 is detected (step S104; Yes), the processing proceeds to step S114, and the processor 120 instructs the exit vehicle 10EX to stop traveling. Thereafter, the processor 120 executes the processes in steps S208, S118, and S120. It should be noted that the process in step S116 (including the warning to the external vehicle 10A) may be executed instead of the process in step S208.

According to the third example described above, when the entry or the approach of the external vehicle 10A is detected by the monitoring process described above, the processor 120 stops the exit vehicle 10EX during the exit to the first target exit space S1 (countermeasure process). As a result, the exit vehicle 10EX can be stopped more quickly, as compared with the example in which, because the monitoring process is not included, it becomes clear that the first target exit space S1 cannot be used due to the presence of the external vehicle 10A after the exit vehicle 10EX has moved to the vicinity of the platform 2. This increases the possibility that the stopped exit vehicle 10EX will not obstruct the entry or the exit of another vehicle 10. Thus, the third example also enables smoother entry and exit. In addition, since the exit vehicle 10EX can be stopped at an early stage, a countermeasure, such as the instruction to the external vehicle 10A (step S208), can also be started quickly. This can lead to early resolution of the entry or the approach of the external vehicle 10A.

### 3-4. Fourth Example

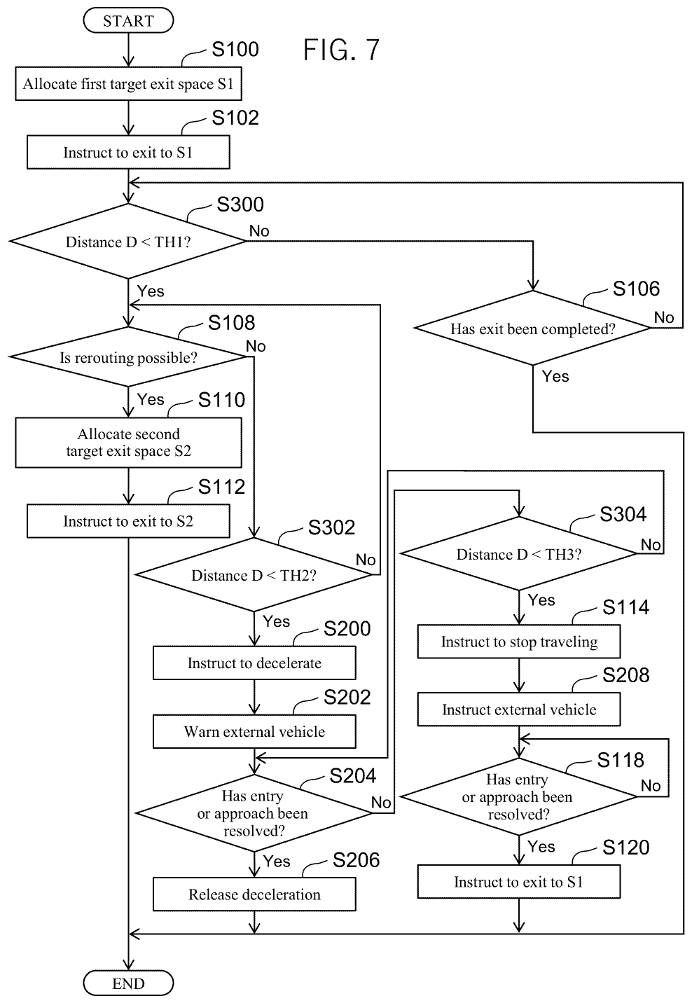

FIG. 7 is a flowchart illustrating processing steps related to the countermeasure process according to the fourth example. The processing of this flowchart is different from the processing of the flowcharts shown in FIGS. 4 and 5 in the following points.

In FIG. 7, after step S102, the processing proceeds to step S300. In step S300, the processor 120 determines whether or not the external vehicle 10A is detected and the distance D becomes shorter than a designated first threshold value TH1. As described above, the distance D is a distance of the external vehicle 10A from the first target exit space S1. As a result, when the external vehicle 10A is not detected or when the distance D is equal to or longer than the first threshold value TH1 (step S300; No), the processing proceeds to step S106.

On the other hand, when the distance D of the detected external vehicle 10A becomes shorter than the first threshold value TH1 (step S300; Yes), that is, when the external vehicle 10A approaches the first target exit space S1, the processing proceeds to step S108. As a result, when rerouting is possible, the exit of the exit vehicle 10EX to the second target exit space S2 is performed (steps S110 and S112).

Moreover, in FIG. 7, when rerouting is not possible (step S108; No), the processing proceeds to step S302. In step S302, the processor 120 determines whether or not the distance D becomes shorter than a designated second threshold value TH2. The second threshold value TH2 is set to be smaller than the first threshold value TH1. When the distance D is equal to or longer than the second threshold value TH2 (step S302; No), the processing returns to step S108. That is, execution of the rerouting is attempted again.

On the other hand, when the distance D becomes shorter than the second threshold value TH2 (step S302; Yes), that is, when the degree of approach of the external vehicle 10A to the first target exit space S1 becomes high, the processor 120 instructs the exit vehicle 10EX to decelerate (step S200). Then, the processor 120 executes processing associated with the deceleration instruction (steps S202, S204, and S206). Then, when the entry or the approach is not resolved only by the warning (step S204; No), the processing proceeds to step S304.

In step S304, the processor 120 determines whether or not the distance D becomes shorter than a designated third threshold value TH3. The third threshold value TH3 is set to be smaller than the second threshold value TH2. When the distance D is equal to or longer than the third threshold value TH3 (step S304; No), the processing returns to step S204.

On the other hand, when the distance D becomes shorter than the third threshold value TH3 (step S304; Yes), that is, when the degree of approach of the external vehicle 10A to the first target exit space S1 is further increased, the processor 120 instructs the exit vehicle 10EX, which is decelerating, to stop traveling (step S114). Thereafter, the processor 120 executes processing associated with the traveling stop (steps S208, S118, and S120). It should be noted that the condition that the distance D becomes shorter than the third threshold value TH3 is also satisfied when the external vehicle 10A enter the first target exit space S1 (that is, when the distance D becomes zero).

According to the fourth example described above, since the monitoring process and the countermeasure process are executed, smoother entry and exit can be performed as in the first to third examples.

Moreover, according to the fourth example, when the second target exit space S2 can be allocated as a result of the distance D becoming shorter than the first threshold value TH1, the second target exit space S2 is allocated to the exit vehicle 10EX. Then, in response to the external vehicle 10A further approaching the first target exit space S1 (distance D<second threshold value TH2) without being able to allocate the second target exit space S2, the exit vehicle 10EX is caused to decelerate. Thus, an appropriate measure can be taken in accordance with the degree of approach of the external vehicle 10A to the first target exit space S1. In addition, since the allocation of the second target exit space S2 is executed with priority over the deceleration, it is possible to effectively reduce a decrease in the operation rate due to the presence of the external vehicle 10A.

Furthermore, according to the fourth example, in response to the external vehicle 10A further approaching the first target exit space S1 (distance D<third threshold value TH3) when the exit vehicle 10EX is decelerating, the exit vehicle 10EX is stopped. This also makes it possible to take an appropriate measure in accordance with the degree of approach of the external vehicle 10A to the first target exit space S1.

### 3-5. Fifth Example

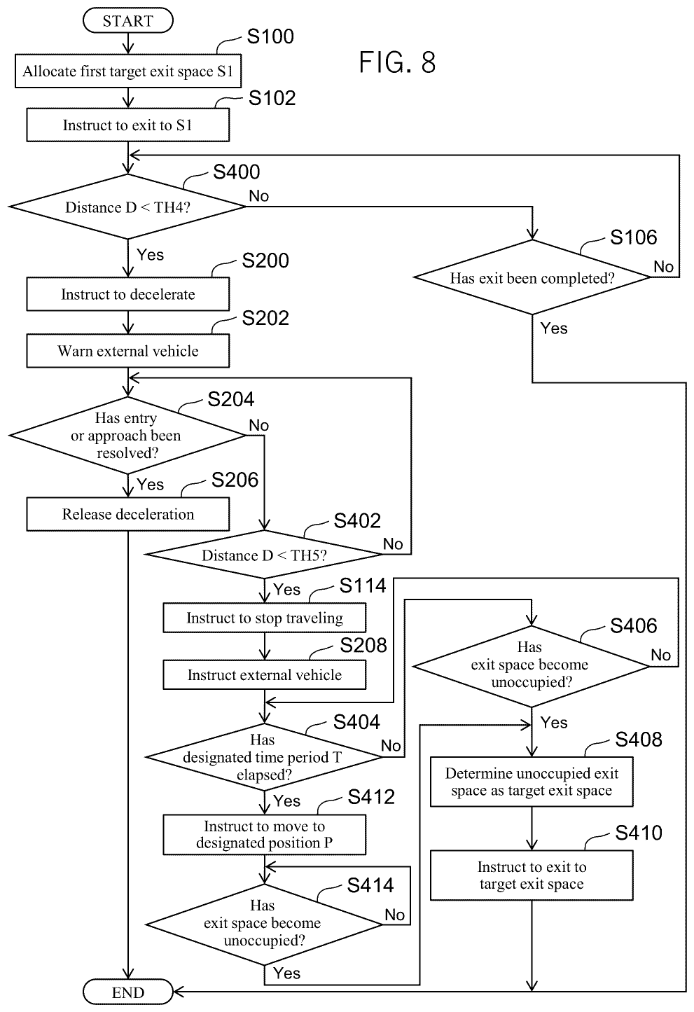

FIG. 8 is a flowchart illustrating processing steps related to the countermeasure process according to the fifth example. The processing of this flowchart is different from the processing of the flowchart shown in FIG. 7 in the following points.

In FIG. 8, after step S102, the processing proceeds to step S400. In step S400, the processor 120 determines whether or not the external vehicle 10A is detected and the distance D becomes shorter than a designated fourth threshold value TH4. For example, the fourth threshold value TH4 may be the same as the first threshold value TH1 or the second threshold value TH2 (see FIG. 7).

When the distance D of the detected external vehicle 10A becomes shorter than the fourth threshold value TH4 (step S400; Yes), the processor 120 instructs the exit vehicle 10EX to decelerate (step S200). Then, the processor 120 executes processing associated with the deceleration instruction (steps S202, S204, and S206).

Moreover, in FIG. 8, when the entry or the approach is not resolved only by the warning (step S204; No), the processing proceeds to step S402. In step S402, the processor 120 determines whether or not the distance D becomes shorter than a designated fifth threshold value TH5. The fifth threshold value TH5 is set to be smaller than the fourth threshold value TH4. For example, the fifth threshold value TH5 may be the same as the third threshold value TH3 (see FIG. 7). When the distance D is equal to or longer than the fifth threshold value TH5 (step S402; No), the processing returns to step S204.

On the other hand, when the distance D becomes shorter than the fifth threshold value TH5 (step S402; Yes), that is, when the degree of approach of the external vehicle 10A to the first target exit space S1 becomes high, the processor 120 instructs the exit vehicle 10EX to stop traveling (step S114). Then, processor 120 executes the processes related to the instruction to the external vehicle 10A (step S208). In FIG. 8, after step S208, the processing proceeds to step S404.

In step S404, the processor 120 determines whether or not a designated time period T has elapsed. This designated time period T corresponds to the elapsed time since the exit vehicle 10EX is caused to stop by the process in step S114.

When the designated time period T has not elapsed yet (step S404; No), the processing proceeds to step S406. In step S406, the processor 120 uses the infrastructure sensor 141, for example, to determine whether or not any of the drop-off/pick-up spaces 6-8 (including the first target exit space S1) that can be used as the target exit space has become unoccupied.

When none of the drop-off/pick-up spaces 6-8 are available (step S406; No), the processing returns to step S404. On the other hand, when any of the drop-off/pick-up spaces 6-8 has become unoccupied (step S406; Yes), the processing proceeds to step S408. In step S408, the processor 120 determines, as a target exit space (i.e., the first target exit space S1 or the second target exit space S2), an exit space (i.e., any one of the drop-off/pick-up spaces 6-8) that is unoccupied. Then, in step S410, the processor 120 instructs the exit vehicle 10EX to exit to the target exit space.

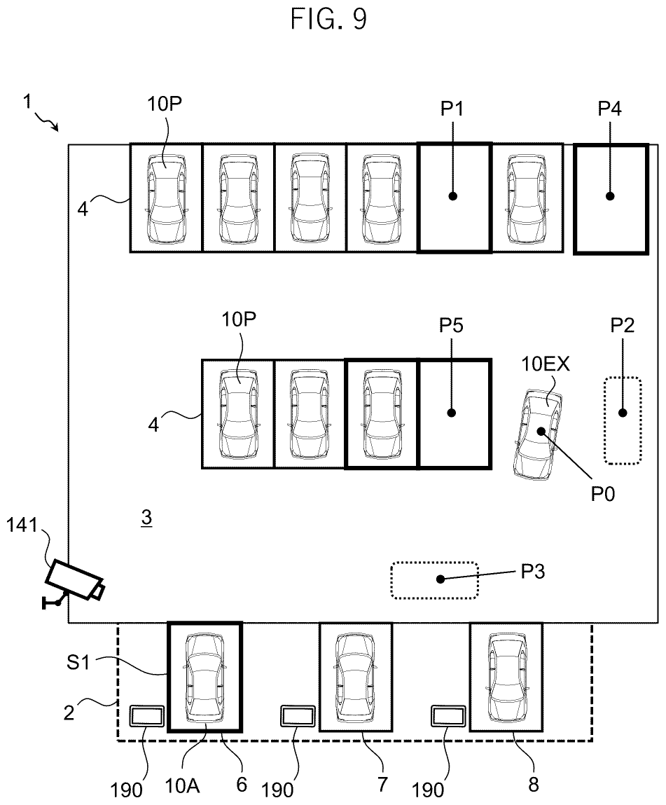

On the other hand, when the designated time period T has elapsed without the target exit space being determined (step S404; Yes), that is, when the first target exit space S1 or the second target exit space S2 does not become allocatable to the exit vehicle 10EX before the designated time period T elapses, the processing proceeds to step S412. In step S412, the processor 120 instructs the exit vehicle 10EX to move to a designated position P (see FIG. 9 described below). Thereafter, when any of the drop-off/pick-up spaces 6-8 has become unoccupied (step S414; Yes), the processes in steps S408 and S410 described above are executed.

FIG. 9 is a diagram used to describe a specific example of the designated position P shown in FIG. 8. The designated position P is, for example, an exit start position P1 of the exit vehicle 10EX. The exit start position P1 is a position of the parking space 4 in which the exit vehicle 10EX was previously parked.

Moreover, the designated position P may be a position P2 that does not obstruct the passage of other vehicles 10 for the entry or the exit, compared to the current stopping position P0 of the exit vehicle 10EX. The position P2 is determined in advance in consideration of, for example, the shape of the parking lot 1 which is a target of the automated valet parking, and is stored in the memory device 130 as the parking lot map information 160. The current stopping position P0 is the position of the exit vehicle 10EX that is stopped based on the travel stopping instruction at step S114 in FIG. 8.

Moreover, the designated position P may be a position P3 closer to one or more exit-space candidates than the current stopping position P0. In the example shown in FIG. 9, the “one or more exit-space candidates” mentioned here correspond to the drop-off/pick-up spaces 6-8 that can be determined as the first target exit space S1 or the second target exit space S2. Similarly to the position P2, the position P3 is determined in advance in consideration of the shape of the parking lot 1 which is a target of the automated valet parking, for example, and is stored in the memory device 130 as the parking lot map information 160.

Furthermore, the designated position P may be a position P4 of a standby space. The standby space is provided in advance separately from the parking spaces 4, and the position P4 is stored in the memory device 130 as the parking lot map information 160. Alternatively, the designated position P may be a position P5 of an unoccupied parking space 4.

According to the fifth example described above, since the monitoring process and the countermeasure process are executed, smoother entry and exit can be performed as in the first to fourth examples.

Also, according to the fifth example, the deceleration of the exit vehicle 10EX is executed in response to the fact that the distance D becomes shorter than the fourth threshold value TH4. Then, the exit vehicle 10EX is stopped in response to the fact that the distance D becomes shorter than the fifth threshold value TH5 (<TH4). Thus, it is possible to take an appropriate measure in accordance with the degree of approach of the external vehicle 10A to the first target exit space S1.

Further, according to the fifth example, when the first target exit space S1 or the second target exit space S2 cannot be allocated to the exit vehicle 10EX before the designated time period T elapses after the exit vehicle 10EX is caused to stop, the processor 120 moves the exit vehicle 10EX to the designated position P. As a result, the following effects can be obtained in accordance with the individual designated positions P.

That is, first, when the designated position P is the “exit start position P1”, the “position P2 that is unlikely to be an obstacle”, the “position P4 of the standby space”, or the “position P5 of the unoccupied parking space” as illustrated in FIG. 9, the following effects are obtained. That is, when the exit vehicle 10EX is stopped for a long time at the unintended current stopping position P0 due to the presence of the external vehicle 10A, smooth entry and exit of another vehicle 10 may be obstructed depending on the current stopping position P0 and the congestion status in the parking lot 1. In contrast, according to the position P1, P2, P4, or P5, the exit vehicle 10EX can be moved to a more suitable place from the viewpoint of smooth management of the entry and the exit in the entire parking lot 1 including other vehicles 10. In addition, according to the exit start position P1, the position P4, or the position P5, it is possible to more reliably prevent the passage of other vehicles 10 from being obstructed, compared to the position P2. Further, according to the position P4, although a space which is not used as the parking space 4 is needed, there is an advantage that the entry of other vehicles 10 into the parking lot 1 are not obstructed in comparison with the exit start position P1 and the position P5. Furthermore, when the position P5 is closer to the target exit space S1 or S2 than the exit start position P1, selecting the position P5 instead of the exit start position P1 is desirable for the user X because the time taken to exit the parking lot 1 after the exit vehicle 10 resumes traveling is shortened.

On the other hand, when the designated position P is the position P3 illustrated in FIG. 9 (i.e., a position closer to the exit-space candidate than the current stopping position P0), the following effects are obtained. That is, when the time has come for the exit of the exit vehicle 10EX to be executable again, the exit vehicle 10EX can be quickly exited as compared with the example in which the exit start position P1 is used as the designated position P. In addition, the position P3 may be determined to be a position that is closer to the exit-space candidate than the current stopping position P0 and that does not obstruct the passage of other vehicles 10 than the current stopping position P0.

In addition, in the processing shown in FIG. 8, when the distance D becomes shorter than the fifth threshold value TH5 (step S402; Yes), the processes related to the rerouting (steps S108 to S112) may be executed instead of the processes related to the stopping of the exit vehicle 10EX (steps S114 and S208). Then, when the rerouting is not possible (step S108; No), the processing may proceed to the processes related to the stopping (steps S114 and S208).

Furthermore, the processes in steps S404 to S414 in FIG. 8 may be executed instead of the processes in steps S118 and S120 in the flowchart of FIG. 4, 5, 6, or 7 described above.

What is claimed is:

1. An automated valet parking management system for managing automated valet parking in a parking lot, the automated valet parking management system comprising:
one or more recognition sensors configured to recognize a surrounding situation of the parking lot; and
processing circuitry configured to execute:
an allocation process of allocating a first target exit space to an exit vehicle from the parking lot;
a monitoring process of using the one or more recognition sensors to detect entry or approach of an external vehicle to the first target exit space from outside the parking lot after the first target exit space is allocated to the exit vehicle; and
a countermeasure process of allocating a second target exit space to the exit vehicle, or decelerating or stopping the exit vehicle that is exiting to the first target exit space, when the entry or the approach is detected by the monitoring process.

2. The automated valet parking management system according to claim 1, wherein
in the countermeasure process, the processing circuitry is configured to:
determine whether or not the second target exit space is allocatable to the exit vehicle, and
when the second target exit space is allocatable, exit the exit vehicle toward the second target exit space with priority over decelerating or stopping the exit vehicle.

3. The automated valet parking management system according to claim 2, wherein
in the countermeasure process, the processing circuitry is configured to stop the exit vehicle when the second target exit space is not allocatable.

4. The automated valet parking management system according to claim 1, wherein
in the countermeasure process, the processing circuitry is configured to:
allocate the second target exit space to the exit vehicle on condition that the second target exit space is allocatable, in response to a distance of the external vehicle from the first target exit space becoming shorter than a first threshold value, and
decelerate the exit vehicle in response to the distance becoming shorter than a second threshold value smaller than the first threshold value without being able to allocate the second target exit space.

5. The automated valet parking management system according to claim 4, wherein
in the countermeasure process, the processing circuitry is configured to stop the exit vehicle in response to the distance becoming shorter than a third threshold value smaller than the second threshold value.

6. The automated valet parking management system according to claim 1, wherein
in the countermeasure process, the processing circuitry is configured to:
decelerate the exit vehicle in response to a distance of the external vehicle from the first target exit space becoming shorter than a fourth threshold value, and
stop the exit vehicle in response to the distance becoming shorter than a fifth threshold value smaller than the fourth threshold value.

7. The automated valet parking management system according to claim 1, wherein
in the countermeasure process, the processing circuitry is configured to move the exit vehicle to: an exit start position of the exit vehicle; a position that does not obstruct passage of another vehicle compared to a current stopping position of the exit vehicle; a position closer to one or more exit-space candidates than the current stopping position of the exit vehicle; a standby space; or an unoccupied parking space, when the first or second target exit space does not become allocatable to the exit vehicle before a designated time period elapses after the exit vehicle is caused to stop.

8. An automated valet parking management method for managing automated valet parking in a parking lot, the automated valet parking management method, which is executed by a computer, comprising:
an allocation process of allocating a first target exit space to an exit vehicle from the parking lot;
a monitoring process of using one or more recognition sensors configured to recognize a surrounding situation of the parking lot to detect entry or approach of an external vehicle to the first target exit space from outside the parking lot after the first target exit space is allocated to the exit vehicle; and
a countermeasure process of allocating a second target exit space to the exit vehicle, or decelerating or stopping the exit vehicle that is exiting to the first target exit space, when the entry or the approach is detected by the monitoring process.
